(19) United States
(12) Patent Application Publication
(10) Pub. No.: US 2026/0159962 A1
(43) Pub. Date: Jun. 11, 2026

(54) FUSION OF GLASS/CERAMIC TO INDUSTRIAL METALLIC SUBSTRATES

(71) Applicant: COVALENT COATING TECHNOLOGY, INC., East Hartford, CT (US)

(72) Inventor: Orville BAILEY, East Hampton, CT (US)

(73) Assignee: COVALENT COATING TECHNOLOGY, INC., East Hartford, CT (US)

(21) Appl. No.: 18/877,498

(22) PCT Filed: Jun. 21, 2023
(86) PCT No.: PCT/US2023/068783

§ 371 Date: Dec. 20, 2024

Related U.S. Application Data
(60) Provisional application No. 63/353,917, filed on Jun. 21, 2022.

(51) Int. Cl. C23D 5/02; C03C 8/14; C04B 35/626; C23D 7/00

(52) U.S. Cl. CPC C23D 5/02; C03C 8/14; C04B 35/6264; C23D 7/00; C03C 2207/04

(57) ABSTRACT

A process for fusing a glass-ceramic to a metal substrate is disclosed. In a preferred embodiment, the process includes grit blasting a metallic substrate (e.g., steel) to remove a surface layer of the metal; after blasting, cleaning the abrasion residue off the surface layer; blending a solvent to use as a suspension agent; creating a suspension of class-coating powders in the solvent solution; depositing the suspension onto the metallic substrate; drying thoroughly the suspension-coated metallic substrate; inserting the dried, coated substrate into a non-reactive chamber, purging the chamber with an inert gas, such as pure argon; and firing the metallic substrate, inside the furnace, in the inert gas. The process forms a robust fusion between the glass/ceramic and steel. This process can be used for various industrial applications.

### FIELD OF INVENTION

This invention and its embodiments concern ceramic suspensions and methods for applying and chemically bonding glass and ceramic materials onto metal substrates to provide protective layers on metallic components. Glass and ceramic layers disclosed herein may bond with a variety of different tempered and untempered metallic substrates. These coatings tightly adhere to industrial products and devices to protect them from various environmental conditions including extreme temperatures, caustic chemicals, high pressures, and severe abrasives.

### BACKGROUND OF THE INVENTION

There has been limited success in achieving adhesion of glass or ceramic (glass, glass-ceramic and ceramic referred to collectively as ceramic) to tempered and untempered metal (e.g., steel, carbon steels, chrome steels, nickel based, and common titanium alloys). It is known that a ceramic is a vitrified glass. Vitrification can be performed by heat treatment. Industrial steels include stainless steel, chrome molybdenum, cobalt chrome and other low alloy steels. These materials have high strength and hardenability, high durability, low deformation during quenching, high creep strength and long-lasting strength at high temperature. Current processes yield inconsistent ionocovalent bonds in the molecular structure which is why most industrial ceramic coatings are plasma sprayed. These coatings are characterized by mechanical interfacial bonds.

Various manufacturing engineers and technologists have attempted to coat metallic components with ceramics using enameling, rapid immersion in molten glass, or plasma spraying techniques. Although some of these coatings have excellent in-vitro behavior, the coatings were characterized by delamination, cracking and poor integrity of the ceramic-metal interface. These imperfect coatings were due to undesirable oxides inherent in the processing techniques.

Tenacious coatings made with ceramics on a metal alloy, or on some other metals, are known to have limited success. There are a variety of defects that could lead to faulty surfaces. For coated metal hardware, a defective coating poses application risks such as spallation and rapid wear. Spallation is a process in which fragments of material (spall) are ejected from a component due to impact or stress. A successful coating technology requires that the component function for many hours and not fail due to the device applications. Homogeneity of the metal and any coating applied, and continuity of that coating within the design, is required to assure there is no gap that can lead to rapid peeling.

One approach to adhering the coating to the metal substrate is by chemically bonding the material to the substrate versus mechanically bonding to the substrate. This was disclosed in U.S. Pat. No. 9,421,303 B2 by preparing both the substrate and ceramic to create a covalently and ionocovalently bonded interface that is stronger than previous interfaces attempted by other ceramic to metal systems. The disclosed process in the '303 patent, the disclosure of which is incorporated herein by reference, allowed strong ionocovalent bonding between the ceramic and metallic layers and was useful for applications that required only thin applications of ceramic coating, such as those utilizing biocompatible ceramic coatings on dental and medical devices. However, these coatings have limited industrial utility where similar ionocovalent bonding is desirable, but thicker and more robust coatings are required.

An improvement to the methods disclosed in the '303 patent was sought related to the use of volatile solvents with low boiling points to create the ceramic suspension that was sprayed onto metallic surfaces. Volatile organic solvents were used so that the layers deposited onto metal surfaces could be thoroughly dried before placing it in an oven for heating. This was an important step for several reasons. First, to achieve the covalent bonding described in this patent, it was necessary for the metal surface and ceramic layer to be clean and free of solvents or other impurities, especially those containing oxidizing moieties like oxygen. Second, residual solvent left in the layer would cause dynamic delamination, which occurs when the solvent gasifies and expands during heating causing damage and lack of uniformity of the layer.

The step of drying a ceramic layer of volatile organic solvents causes several manufacturing and production issues. For example, drying layers of ceramic powder onto metal surfaces presents undesirable durability. During and after the steps of drying the ceramic layer onto the metal surface, the dried ceramic layer is delicate and prone to damage and pre-processing discontinuity. For example, great care must be taken when transferring a ceramic coated metal object into a furnace for heat treatment. Not only would damage to the layer occur upon handling, but gentle vibrations would also cause significant loss of ceramic material from the metal surface. This can lead to inconsistent coatings with poor layer uniformity.

While the processes disclosed in the '303 patent are excellent for coating thin ceramic layers onto metallic surfaces, they have limited utility for applying thicker ceramic layers, namely those having a thickness of 0.007 to 0.100 inches or above. Part of the reason for this is incomplete drying of the ceramic layer. During the step of drying thicker ceramic layers, a portion of the volatile solvents is often left behind leading to greater opportunity for dynamic delamination when heated. Moreover, thicker ceramic layers were subject to greater levels of damage during drying and transport, leading to more issues with uniformity and durability. The present invention addresses this need.

### OBJECTS AND SUMMARY OF THE INVENTION

Accordingly, it is a primary object of the present invention to strongly bond ceramic to metal substrates, preferably through chemical bonding such as covalent or ionocovalent bonding. It is required for the metal surface to have freely available bonds that will chemically bond with the ceramic coating upon heat processing. These bonds are direct ionocovalent bonds (i.e., bonds having some degree of sharing and some degree of separation of electrons). Ionocovalent bonds are preferred as they are much stronger than Van Der Waals bonds, and significantly stronger than mechanical bonding, each of which can be easily removed both purposely and by mishap. For purposes of the present invention, metal or metallic substrates shall be understood to include, without limitation, tempered and untempered metals such as steel, carbon steels, chrome steels, nickel based, and common titanium alloys, copper, aluminum metals, etc.

Another object of the present invention is to minimize issues concerning low durability and delamination of the ceramic layer both before and after curing. A goal of the processes disclosed herein is to coat metallic substrates in a manner that produces homogeneous and durable strongly bonded ceramic coatings without gaps or other coating defects. It is also a goal of this invention is to provide a process that binds uncured ceramic suspensions onto metal surfaces that do not dry prior to heat curing, allowing for thicker coatings and are sufficiently durable for light transport.

Another object of the present invention is to provide the ability to create chemically bonded ceramic layers with a variety of thicknesses on metallic substrates. By increasing the versatility of the coating processes disclosed herein, coatings can be made for a greater number of applications in multiple different industries. For example, similar processes can be used for thinner ceramic coatings, that may be desirable for medical or other fine applications, and thicker ceramic coatings that may have heavier industrial applications.

Another object of the present invention is the creation of a semi-intermetallic ceramic layer on the metallic substrate. Intermetallics typically comprise a metallic alloy that forms an ordered solid-state compound between two or more metallic elements. Intermetallics are generally hard and brittle, with good high-temperature mechanical properties. The semi-intermetallic ceramic layer described herein occurs at and near the boundaries of the ceramic-metal interface and comprises mechanically and chemically bonded metallic substrate and ceramic coating up to about 0.0025 inches thick. Multiple bonds occur at the surface of the metallic substrate and within the semi-intermetallic ceramic layer ranging from covalent and ionocovalent bonds to mechanical bonding to produce a tenacious coating for a myriad of applications requiring increased hardness, high durability, and resistance to corrosion.

Another object of the present invention is management of the coefficient of thermal expansion. The coefficient of thermal expansion is the characteristic of a material to change volume due to the change in temperature. Typically, metals have a higher thermal expansion coefficient than ceramics which can lead to poor performance of ceramic coated metal exposed to a high range of temperatures. Thermal expansion capability generally decreases with increasing bond energy. Thus, strong bonds formed between metal and ceramic are required to ensure that the base metal and ceramic coating can thermally expand without delamination or other forms of failure.

It is yet another object of the invention to create a novel metal tempering process that provides a strong and durable ceramic coating on the metallic substrate surface. This tempering process serves both ceramic crystallization and stabilization and proper metal phase definition. The ceramic stabilization relieves internal stresses while the metal substrate phase is determined by the defined time and temperature.

Applicant has invented a method for applying ceramic coatings to metal substrates —namely, steels or other specialty and industrial metallic substrates—that ensures a chemically bound and impervious seal of the ceramic coating to the metal substrate in a manner that resists coating failure by delamination, spalling or other means.

In some preferred embodiments, Applicant's process comprises: grit blasting a metallic substrate to remove a surface layer of the metal; cleaning any abrasion residue off the metal; blending one or more solvents, for example isopropanol and glycerin, to use as a suspension and binding agent; creating a suspension of ceramic powders in the solvent solution; depositing the suspension onto the metallic substrate by, for example, spraying or dipping; allowing the coated to settle onto the metallic substrate for several minutes; inserting coated metal substrate into a non-reactive chamber, purging the chamber with an inert gas, such as pure argon; and firing the metallic substrates, inside the furnace.

Preferred embodiments of the present invention incorporate one or more binding solvents that do not dry at room temperature and help adhere the uncured layer of ceramic to the metal substrate prior to heating in an oven. It was found that binding solvents provide a durable uncured ceramic layer that has significant advantages over prior art. Glycerin is an example of a non-drying binding solvent that adheres the uncured ceramic layer in place prior to heat curing. Because glycerin does not dry at ambient temperatures, it can help adhere the uncured layer for long periods of time. Due to limited level of drying, the applied coating retains its initial tack which helps it adhere to the substrate. This uncured coating is resistant to damage and can be transported. Coated hardware can sustain significant vibrations of up to 150 pounds of force over cyclical loading during shipping.

### BRIEF DESCRIPTION OF THE DRAWINGS

The above objects and other advantages of the invention will become more readily apparent upon reading the following description and drawings, in which:

FIG. 1 depicts a cross-sectional view of a passivated substrate of metal (steel) with an oxide layer;

FIG. 2 depicts a micro-structural cleaning (here, grit blasting) of the steel substrate to remove the passivated oxide layer;

FIG. 3 depicts an ablated steel substrate after cleaning;

FIG. 4 depicts spraying a coating of ceramic onto a cleaned, ablated substrate; and

FIG. 5 depicts the coated substrate after being heat treated (fired) in an atmospheric furnace and subsequently cooled.

### DETAILED DESCRIPTION

The materials and methods disclosed herein create superior bonding of ceramic to metal with little to no delamination or failure. The metal substrate may be prepared by removal of surface contaminants such as oxides, nitrides, carbides, and other impurities to produce free bonds that will readily adhere to the ceramic when heat cured. Preparation of the surface of metal can be done via various means known to those of ordinary skill including, without limitation, one or more of the following: grit blasting; pickling; chemical milling/etching; laser ablation; ion ablation; reverse arc; water/liquid jet (with or without media); laser; or sonic agitation. The purpose of the surface ablation is to remove passivated and other metal compounds from the surface in preparation for coating. The metal surface should have freely available bonds that will chemically join with the coating upon processing. These bonds are direct covalent and ionocovalent bonds (i.e., bonds having some degree of sharing and some degree of separation of electrons). These chemical bonds are preferred as they are much stronger than Van Der Waals bonds, which can be easily removed in the shear direction. Enough surface of the substrate must be removed to ensure total removal of the passivated surface. For purposes of the present invention, it will be appreciated that the surface layer of the metal substrate shall be understood to include the outer or exterior portion of the substrate which has undergone some level of oxidation or passivation or contamination and this surface layer requires removal or substantial reduction in order for adhesion of the coating to sufficiently occur. For the sake of simplicity of description rather than for purposes of exclusion, reference herein to a “passivated surface” or “external layer” of the metallic substrate shall be understood to include the surface portion of the substrate having thereon one or more of passivation, oxidation, or contamination, etc. and removal of that layer shall include not only complete removal but also substantial or sufficient removal of the undesirable layer to an extent that the desired coating can be applied and sufficiently adhere.

In some embodiments, preparation of the metallic surface may include grit blasting to micropit and to remove the passivated surface thereon. FIG. 1 depicts a cross-sectional view of a passivated substrate of metal (steel) 100 with an oxide layer 102. Physical, microstructural or chemical removal of the oxide layer 102 is preferred to enable the formation of both mechanical and chemical bonds with ceramic at the metallic substrate surface

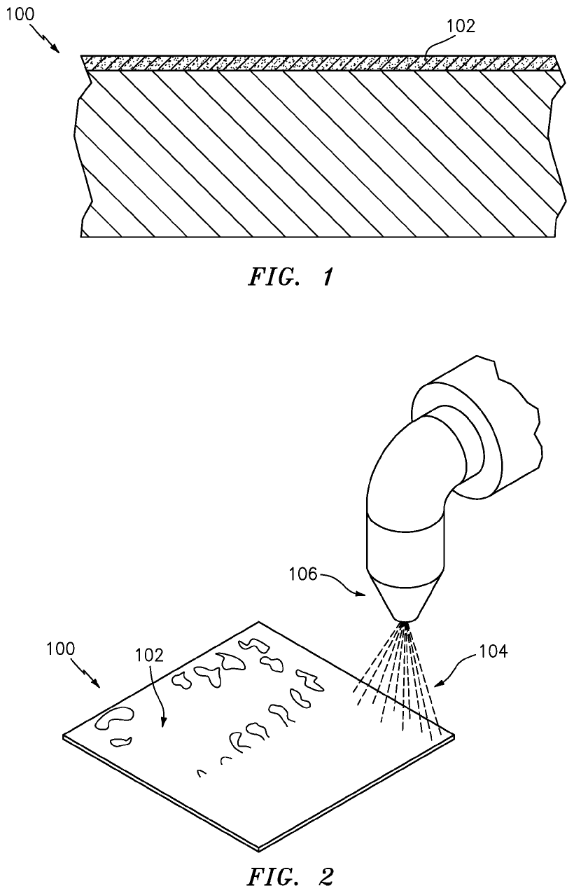

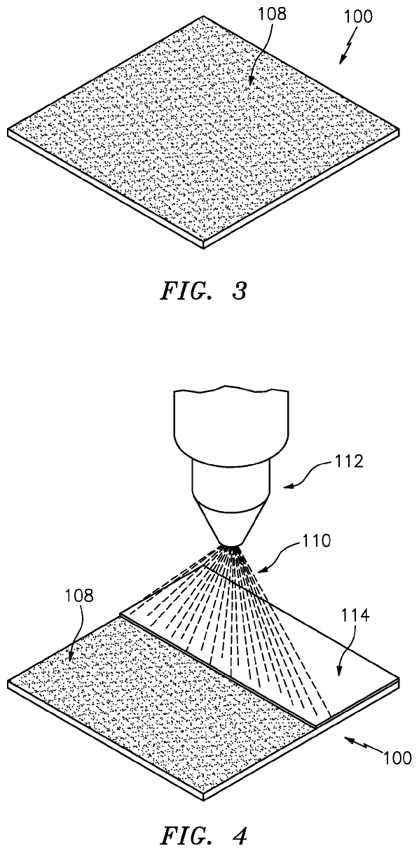

A preferred method of removing a passivated surface is grit blasting. FIG. 2 depicts micro-structural cleaning with a grit blaster 106 removing an oxide layer 102 from a metal substrate 100 using grit 104. By way of example, grit blasting may be performed using #120 mesh (150-50 mesh range) white aluminum oxide grit at a 3 inch relief distance at 30 psi (25-100 psi range). Duration and strength of grit blasting may be determined by persons of ordinary skill in the art based on the application and changes in surface color and texture of metal surface. Duration and strength of grit blasting only need to be sufficient to remove an oxide layer. Duration should be 15 seconds minimum per discreet area, 2 inch radius, and 30 psi pressure.

After grit blasting, the metal surface may be cleaned with a solvent to remove the abrasion residue from the surface. For example, in some embodiments, the surface may be cleaned with organic solvents. In other embodiments, the surface can be cleaned with aqueous solutions. In some embodiments, solvent mixtures can be used, such as organic alcohols in water. For example, in some preferred embodiments 90% isopropyl alcohol may be used to clean the metal surface. This cleaning step can be repeated as many times as necessary to ensure a clean metallic surface. For smaller parts, an ultrasonic bath of 90% isopropyl alcohol may be used in addition to a final 90% isopropyl rinse cycle. FIG. 3 depicts an ablated steel substrate 100 after micro-structural cleaning and rinsing with solvent. The ablated surface 108 is devoid of an oxide layer and has free metallic electrons to bond with ceramic.

When cleaning larger surface areas, you may perform three or more rinsing cycles to ensure the surface is completely devoid of ablation residue. For example, you may rinse a first time with water, rinse a second time with a mixture of water and lye (e.g., 8 ounces lye with 16 ounces water), rinse a third time with water, and rinse a fourth time with isopropyl alcohol. The objective is to remove all particles and other foreign substances and chemicals on the metallic substrate that may block bonding with the ceramic layer and the formation of a semi-intermetallic interface between the metallic and ceramic layers. Once complete, the cleaned metal surface may be dried and stored in a clean controlled environment, preferably in an atmosphere of filtered clean air or noble gas to prevent dust from settling onto the surface or surface corrosion prior to coating.

Applicant's preferred step of post-surface ablation cleaning is ultrasonic baths, typically using an alcohol-based bath to remove foreign surface objects (e.g., residual dust, other particles, and liquids) that may be present on the surface of the ablated metal. These foreign particles and liquids may be a by-product of the ablation cleaning. It is important to remove these foreign particles as they could foul the coating in several different ways depending upon the chemical constitution of the particle, the coating material and the surface. Fouling of the coating includes, but is not limited to, the following: burn up during coating firing producing a defect, reacting with the ceramic or the surface to create a defect, or remain inertly on the surface to create a defect. Any residue may also promote coating delamination.

A suspension of ceramic powders in one or more solvents can be premade and stored for later use, or alternatively prepared just before coating the metal surface. The suspension may be created with a 1:1 ratio by weight of ceramic powder to solvent. Some applications requiring thicker ceramic coatings may require greater concentrations of ceramic powder in suspension. Ceramic powder to solvent ratios may include a range of about 0.01:1 to 100:1 by weight. The powder to solvent ratio preferably includes a range of about 0.2:1 to 50:1. Preferred powder to solvent ratios include 0.5:1, 1.5:1, 2:1, 3:1, 4:1 and 5:1. Variations of these ratios may be used depending on the type of ceramic and metal substrate, and the specific needs of the part being coated.

Several solvents and solvent mixtures may be used to make ceramic powder suspensions in accordance with several embodiments of this invention. Surprisingly, it was found that certain solvents could be used in the ceramic suspension that do not completely dry at ambient temperatures prior to the heat curing process. Specifically, it was found that certain binding solvents could be used that may be added to an oven prior to drying and can be heat cured without dynamic delamination failure, and without disturbing the strength of the heat cured bond of the metal and ceramic layers. Surprisingly, these solvents did not cause dynamic delamination failure from escaping gasses passing through the ceramic layer during the curing process, and did not disrupt the strong mechanical and chemical bond formation between ceramic layers and metallic surfaces.

Several embodiments of the present invention may include one or more binding solvents with higher viscosity, surface tension, and/or boiling points that do not dry prior to heat curing the coated sample, and enable the coating to stick to the surface better than a dried ceramic coat. For example, some embodiments of the present invention may comprise one or more binding solvents having a viscosity between 1 and 2000 centipoise, preferably about 900 centipoise, and boiling points greater than 100° C., preferably about 290° C. Some preferred embodiments include one or more binding solvents having a viscosity of between 600 and 1200 centipoise, and boiling points greater than 200° C. Using solvents with higher viscosities and boiling points allows for thicker suspensions that do not dry when applied to metal surfaces until exposed to heat. It was found that suspensions comprising binding solvents having high viscosity and boiling points provide uncured ceramic layers—namely, ceramic-coated metal surfaces prior to heating—that resist drying, sloughing, cracking, vibrational damage, and other issues common with uncured coatings at ambient temperatures. Binding solvents may also be used in solvent mixtures further comprising volatile solvents—those with boiling points less than 100° C.—to dilute the binding solvents as required for a given application. Volatile solvents that may be used to dilute binding solvents include many organic solvents that are miscible with the chosen binding solvents. Examples of preferred volatile solvents include, but are not limited to: 1-propanol; isopropanol; methanol; ethanol; denatured alcohol; tert-butyl alcohol; acetone; and ketones. The binding solvents may comprise between 0.1% and 10.0% by weight of a solvent mixture that is used to make a ceramic suspension.

It was found that polar solvents capable of hydrogen bonding—including those comprising oxygen—could be used as binding solvents. Surprisingly, it was found that these solvents do not interfere with the covalent and ionocovalent bond formation between the ceramic layer and the metal substrate during the heat curing process. By way of example, several organic alcohols may be included as binding solvents used to make ceramic suspensions that adhere to metal surfaces. Organic alcohols have both hydrophobic and hydrophilic characteristics that can be used with many other solvents of different polarity, and can help adhere the uncured ceramic suspension to the metal surface. Moreover, hydrogen bonding increases the surface tension and boiling points of organic alcohols, which resists evaporation at room temperatures and remain tacky to touch. The use of these and other tacky non-drying binding solvents in the ceramic suspension allows for thicker more durable layers of uncured ceramic coating onto metal surfaces. Polyols have high viscosity and boiling points, and provide excellent tackiness for use as binding solvents that strongly adhere uncured ceramic layers to metallic substrates. Glycerin is an example of a preferred polyol binding solvent.

Other binding solvents that may be used in ceramic suspensions may include, without limitation, one or more of the following: diethylene glycol; propylene glycol; dimethyl sulfoxide; dimethylformamide; tert-amyl alcohol; benzyl alcohol; 1,4-butanediol; 1,2,4-butanetriol; butanol; 2-butanol; propylene glycol methyl ether; di(propylene glycol) methyl ether; diethylene glycol; ethylene glycol; 2-ethylhexanol; furfuryl alcohol; isobutanol; 2-(2-methoxyethoxy) ethanol; 2-methyl-1-butanol; 2-methyl-1-pentanol; 3-methyl-2-butanol; neopentyl alcohol; pentanol; and 1,3-propanediol.

In preferred embodiments, glycerin may be used as a binding solvent that binds the uncured ceramic layer in place prior to heating. For example, because glycerin does not dry at ambient temperatures, it can bind the uncured layer for an indefinite amount of time. This uncured layer is resistant to damage and can be transported over distances, including across industrial sites or transported by vehicle. For example, coated metal surfaces can sustain significant vibrations of up to 150 pounds of force over cyclical loading. This durability has several advantages, including the possibility of shipping uncured ceramic-coated surfaces.

Some preferred embodiments of the present invention comprise a combination of N-propyl alcohol and glycerin as a solvent mixture to create the ceramic suspension. It was surprisingly found that a combination of these two solvents had benefits of reduced failure by dynamic delamination and did not disrupt strong bond formation during the heat curing process. This solvent mixture may be prepared by blending a solution of 100% Laboratory Grade N-Propyl Alcohol with 100% Glycerin at 99:1 by weight percentage. The preferred glycerin percentage is between 1-10% by weight in n-propyl alcohol. The solvent has a two-fold function: to carry the powder in suspension to the device; and to adhere the suspension to the device during and after it has been deposited (e.g., air-sprayed) onto the metal. The glycerin's function is to assure the coating stays adhered to the substrate prior to heat curing.

Approximately 24 grams of ceramic powder may be blended with 24 grams of the solvent mixture to create the ceramic suspension. The suspension may optionally be treated with 120 grams of Yttria Stabilized Zirconia Grinding Media Spherical 5.0 mm, added to a Nalgene bottle and placed on a ball mill for about 1 hour.

Post ball milling the powder, the suspension may be poured into application bottles for air spray, brushing, rolling, dipping, water falling or other forms of coating onto the metal substrate. Pre-fabricated tapes may also be fabricated and applied. In preferred embodiments, the coating step utilizes air spraying at low pressure, typically about 10 psi minimum, to apply a uniform coating to the cleaned, ablated substrate surface. Other coating processes can be performed to achieve a uniform coating as well, such as aerosol spray, dipping, and brushing, depending on the surface. For example, some metal substrates have small complex surface structures, such as small gears or texture. For these substrates, brushing may be used to ensure an even coat.

FIG. 4 depicts use of a spraying apparatus 112 to spray a ceramic suspension 110 onto an ablated surface 108 to provide an uncured ceramic coating 114 onto metallic substrate 100. For many spray applications, an Iwata Power Jet Lite System was used to spray a suspension at 20 +/−5 psi at a distance of about 1-3 inches. Depending on the substrate, ceramic suspension, temperature and solvent mixture used, an optimal spray distance depends on how fast the volatile solvent dries as the coating must be in mostly liquid form upon contact with the metal surface. For example, a 99:1 n-propyl alcohol to glycerin solvent mixture is best sprayed at 3 inches or less. The coating is allowed to settle onto the treated metal surface prior to placing it in furnace to remove the volatile alcohol and potential flame risk, but leaving the non-volatile glycerin.

Thermal processing of the coated surface may be performed in a standard atmospheric furnace (i.e., a furnace with a controlled atmosphere). This “atmosphere” is designed to prevent non-preferential bonding of the ceramic to the metal substrate. Exposure to oxygen and oxygen-containing solvents like water can create oxidation on the surface of the metal that degrade the strength of the coating by preventing the melted ceramic from forming chemical bonds with the metal. Surprisingly, it was found that oxygen atoms on binding solvents such as glycerin do not have deleterious effects on bonding of ceramic to metal using the novel processes herein.

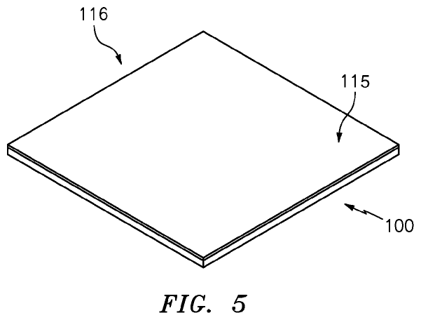

The coated items may then be prepared for thermal processing by mounting the item onto a fixture for insertion into a non-reactive chamber of an atmospheric furnace (i.e., a furnace with a controlled atmosphere and coils for radiant heat for firing), and substantially purging the chamber with pure inert gas, preferably argon. FIG. 5 depicts a coated article 116 comprising a ceramic layer 115 that is chemically and mechanically bonded to metallic substrate 100 after being heat treated (fired) in an atmospheric furnace and subsequently cooled. For larger applications inert Nitrogen can be used. Minimal traces of air, oxygen or nitrogen may be present after purge.

The thermal cycle is determined by the type of ceramic used and its thermal characteristics. The firing and annealing processes for the coating can be designed to minimize thermally induced stresses. An exemplary sequence for firing the coated metal is: insert a fully coated component into an atmospheric furnace; purge the furnace of all air, focusing on oxygen, with an inert gas (preferably argon or nitrogen); initiate a continuous flow of a combustible gas for a thermal cycle; fire the components to a ceramic transition temperature of the selected ceramic; and slow cool the coated components to minimize stress between the ceramic and metal substrate.

Thermal processing of the coated metallic substrate may be carried out inside a furnace in an inert atmosphere. The firing parameters may be dependent on the type of metal substrate being coated as well as the thermal characteristics of the ceramic layer. The thermal treatment step can be used to bond the ceramic coating to the metal substrate and to temper the metal substrate in one process. The heating sequence should be controlled so that dynamic delamination does not occur as the nondrying solvent is burned off. A typical heating sequence may include the following parameters:
a. Room Temperature up to 280° C. for about 0.15 hours
b. 280° C. to 290° C. for about 0.05 hours for bisque/remove aromatics
c. 290° C. to 600° C. for about 0.15 hours for gradual heat increase
d 600° C. to 750° C. for about 0.15 hours for gradual heat increase
e. 750° C. to 825° C. for about 0.20 hours for ceramic transition temperature
f. 825° C. to 825° C. for about 0.20 hours for coating coalescence
g 825° C. to 425° C. for about 3.00 hours to relieve internal coating stresses
h. 425° C. to 425° C. for about 2.00 hours to temper the metal alloy
i. 425° C. to 300° C. for about 1.00 hours to relieve internal coating stresses.

j. Further slow cooling the fired coated metallic substrate to minimize stress between the ceramic and metal substrate at natural furnace cooling rate at end of cycle.

The heating sequence may be modified to temper metallic components at the same time as curing the ceramic coating to the metal. Metallic components are often tempered to obtain the desired microstructure and hardness properties for specific applications. Other heat treatment techniques include annealing, case hardening, precipitation strengthening, carburizing, normalizing and quenching.

Example: a component device comprising untempered 4140 alloy—a Chromium-Molybdenum alloy Steel—was grit blasted to remove the passivated surface layer. The abrasion residue was removed with several rinse cycles including a first rinse with water, a second rinse with an aqueous 50% isopropyl alcohol solution, and a third rinse with 90% isopropyl alcohol. A suspension of zirconia containing glass-ceramic powder with a particle size of about 30 microns was created by mixing the ceramic powder with a solution comprising 2 weight % glycerin in 98 weight % isopropyl alcohol. The ceramic suspension was applied to the component device using the spray method at 30 psi at 2.5″ from the surface to be coated and was allowed to stand for 15 minutes. Tempering for 4140 alloy is typically performed at a temperature range of 650° C. to 200° C. for two hours. The desired phase of the tempered metal determines the actual temperature. The coated component was then inserted into an oven for tempering, heat curing and bonding the ceramic layer. In-situ bonding occures at approximately 825° C. while tempering occurs on the cool down phase of the furnace cycle. A rapid quench typical in tempering is not incorporated as this could spall the coating. The heat sequence used for tempering and heat curing the present coated 4140 alloy component is provided below:

4140 Alloy Tempering and Curing

| Temp(C.) | Time(Hr) |
|---|---|
| 280 | 0.15 |
| 290 | 0.05 |
| 600 | 0.16 |
| 750 | 0.15 |
| 825 | 0.20 |
| 825 | 0.20 |
| 425 | 3.00 |
| 425 | 2.00 |
| 300 | 1.00 |

As used with Applicant's preferred method, an industrial ceramic may contain, but is not limited to, the following components: CaO, SiO₂, Na₂O and, P₂O₅. (Similar chemistries can be used for borosilicate glasses.) Industrial coatings may further contain one or more of the following components: F, ZrO₂, ZnO, CaO, K₂O, SiO₂, Al₂O₃, Na₂O, MgO, P₂O₂, Y₂O₃, Ag₂O₃ and TiO₂. Components may be selected depending upon the desired use of the metal substrate.

Heat curing the coated substrate chemically and mechanically bonds the ceramic and metal. The ceramic may partly or fully vitrify on the metal substrate, depending on the heating sequence used, forming an engineered semi-intermetallic metal-ceramic layer through bonding on the metal-ceramic interface. Preferred embodiments of methods disclosed herein use a controlled atmosphere. Using an improper atmosphere may create compounds that could be deleterious to the bonds formed at the metal-ceramic interface. Purging and heat-treating coated substrates using, for example, one or more inert gasses precludes inadvertent creation/bonding of the undesirable compounds (e.g., metal oxides, nitrides) with the substrate prior to exposure to elevated temperatures and during elevated temperature exposure. Such inert gases include helium, neon, argon and other noble gases. The inert atmosphere can comprise a closed system with positive pressure, or an open system with a constant flow of gasses to keep the atmosphere inert. For example, in some embodiments, a flow or a reservoir of noble gases can be used to create an inert atmosphere to heat cure substrates outside the confines of an oven. In these embodiments, larger coated surfaces can be coated using methods described herein.

Applicant's processes has many benefits, including: producing a chemically pristine substrate with high free energy, free bonds; creating a process for wet coating the metal substrate to create a thicker, stronger, and more durable uncured layer that is not subject to damage in the same manner as dry layers disclosed in the '303 Patent; creating uncured ceramic coatings on metal substrates that are durable enough to withstand transport to other locations for heat curing; producing a process that allows for the uncured ceramic coating to be applied thicker than processes disclosed in the '303 Patent without compromising the strength of the bond with the metal substrate; creating a and may be transported to other locations prior to heat curing; and achieving a direct chemical bond between a ceramic and metal substrate as strong or stronger than the dry coating processes disclosed in the '303 Patent.

Samples were evaluated using a scanning election microscope. This testing was done by training the electrons in a scanning electron microscope in a line perpendicular to the coating and evaluating the x-rays that were emitted from that electron beam/material interaction. This test revealed intimate contact of ceramic to metal. There was a gradual change of chemistry between the 290 micron and 305 micron regions in the line scan suggesting that a diffuse semi-intermetallic interface that is on the order of 10-15 microns in thickness. It should be noted that compounds of oxygen or nitrogen were not detected at the interface.

Surfaces created using the new methods disclosed herein were evaluated to determine the strength of the bonding of ceramic to metal. Scratch testing was performed to characterize the strength of the bond on a coated 4140 metallic substrate. A micro-indenter was loaded, onto the surface, which was then pulled across the micro-indenter in the test used. All samples required significant force to remove the chemically bonded ceramic layer from the metallic substrate. Testing showed that failure occurred at the metal substrate layer below the semi-intermetallic layer. Visible inspection showed that the removed ceramic layer remained tightly bonded to the failed metallic layer, suggesting that the strength of the ceramic-metal chemical bond was stronger than the bonds within the metal substrate. The ceramic surface provided a recorded scratch hardness of about 100N using a 200 um Rockwell Indenter that was used to perform the scratch testing.

It should be understood by those skilled in the art that obvious modifications can be made without departing from the spirit of the invention. Reference therefore should be made primarily to the accompanying claims rather than the foregoing specification to determine the scope of the invention.

1. A suspension for coating a metallic substrate, comprising a binding solvent and a ceramic powder, wherein the binding solvent does not dry at ambient conditions.

2. The suspension for coating a metallic substrate of claim 1 wherein the binding solvent is glycerin.

3. A method of fusing ceramic to an industrial metallic substrate, comprising:
a) treating a metallic substrate having a passivated surface thereon to remove the passivated surface layer of the metallic substrate;
b) removing the abrasion residue off the metallic substrate resulting, after the treating step a);
c) coating the metallic substrate of step b) with a suspension of ceramic powders in a solvent comprising glycerin;
d) inserting the wet-coated metallic substrate of step c) into a furnace chamber with a non-reactive atmosphere;
e) purging the furnace chamber with an inert gas to substantially remove any other gas within the chamber; and
f) heating and cooling the wet coated metallic substrate inside the chamber in the inert gas, to form a metallic substrate having a ceramic layer bonded thereon.

4. The method of claim 3 wherein the metallic substrate is steel.

5. The method of claim 3 wherein passivated surface is removed by grit blasting using a ceramic oxide as an abrasive.

6. A method of fusing a vitrified ceramic to a metallic substrate, comprising:
a) grit blasting the surface layer of a metallic substrate, and having a surface layer with aluminum oxide to remove the surface layer of the steel substrate to minimize the introduction of active foreign particles;
b) cleaning the metallic substrate, after the grit blasting of step a);
c) depositing a suspension of ceramic powders in a solvent onto the metallic substrate resulting from step b) with an air brush until the metallic substrate is fully coated;
d) air drying the coated metallic substrate of step c);
e) inserting the dried coated substrate of step d) into a non-reactive chamber of a furnace with a controlled atmosphere;
f) purging the chamber with an inert gas to substantially remove any other gas within the chamber; and
g) firing the dried coated metallic substrate inside the chamber in the inert gas, whereby a metallic substrate having a vitrified ceramic fused thereon is formed.

7. The method of claim 6 wherein the ceramic is also wear resistant.

8. The method of claim 6 wherein the metallic substrate is steel.

9. The method of claim 6 wherein the inert gas is argon.

10. The method of claim 6 wherein the coated metallic substrate in step h) is heated to at least a ceramic transition temperature of the ceramic.

11. A method of fusing vitrified ceramic to a metallic substrate, comprising:
a) removing the surface layer of the metallic substrate having a surface layer thereon;
b) coating the metallic substrate resulting from step a) with a suspension of glass-ceramic particles in a solvent;
c) drying the suspension coated metallic substrate of step b);
d) inserting the dried coated metallic substrate of step c) into a non-reactive chamber of an atmospheric furnace,
e) purging the chamber with an inert gas to substantially remove any other gas within the chamber;
f) heat processing the coated metallic substrate inside the chamber to at least a ceramic transition temperature of the ceramic, in the inert gas; and
g) cooling the coated metallic substrate to minimize stress between the coating and the metallic substrate, thereby forming a metallic substrate having a vitrified ceramic fused thereon.

12. The method of claim 11 wherein the metallic substrate is steel.

13. The method of claim 11 wherein the inert gas is argon.
